(19) United States
(12) Patent Application Publication
(10) Pub. No.: US 2025/0238624 A1
(43) Pub. Date: Jul. 24, 2025

(54) Behavior Determination Device, Behavior Determination Method, and Behavior Determination Program

(71) Applicant: Hitachi, Ltd., Tokyo (JP)

(72) Inventors: Tadayuki MATSUMURA, Tokyo (JP); Kanako ESAKI, Tokyo (JP); Shunsuke MINUSA, Tokyo (JP); Takeshi KATO, Tokyo (JP); Hiroyuki MIZUNO, Tokyo (JP)

(21) Appl. No.: 18/969,904

(22) Filed: Dec. 5, 2024

(30) Foreign Application Priority Data
Jan. 19, 2024 (JP) 2024-006677

(51) Int. Cl. G06F 40/35; G06N 3/006

(52) U.S. Cl. CPC G06F 40/35; G06N 3/006

(57) ABSTRACT

A behavior determination device executes: search processing of searching for, by executing a simulated conversation between a first agent that simulates a facilitator based on a language model and a second agent that simulates participants based on the language model, a plurality of simulated conversation paths from a start to an end of the simulated conversation, calculation processing of calculating, based on an internal state indicating group recognition for a participant group of the participants in the second agent, an evaluation value for evaluating an utterance of a simulation response sentence in the simulation conversation generated by the second agent in the plurality of simulated conversation paths, extraction processing of extracting, based on the evaluation value, a specific simulated utterance candidate sentence from a plurality of simulated utterance candidate sentences at a start time of the simulated conversation, and output processing of outputting the specific simulated utterance candidate sentence.

### CLAIM OF PRIORITY

The present application claims priority from Japanese patent application No. 2024-6677 filed on Jan. 19, 2024, the content of which is hereby incorporated by reference into this application.

### BACKGROUND OF THE INVENTION

### 1. Field of the Invention

The present invention relates to a behavior determination device, a behavior determination method, and a behavior determination program for determining a behavior.

### 2. Description of Related Art

The following NPL 1 discloses a two-layer facilitation agent which is designed to model a dynamic discussion process as a Markov decision process (MDP) and learn an optimal facilitation policy for multiple rounds of discussion.

### CITATION LIST

### Non Patent Literature

NPL 1: Shiyao Ding and Takayuki Ito, A Deep Reinforcement Learning Based Facilitation Agent for Consensus Building among Multi-Round Discussions, The 20th Pacific International Conference on Artificial Intelligence (PRICAI 2023), Nov. 17-19, 2023, Jakarta, Indonesia.

### SUMMARY OF THE INVENTION

However, in the related art described above, the facilitation agent learns an utterance to support a conversation through reinforcement learning, which thus requires collection and learning of a large amount of facilitation behavior data as training data during execution, and does not take into account efficient consensus building.

A behavior determination device according to one aspect of the invention disclosed in the present application includes: a processor configured to execute a program; and a storage device configured to store the program. The processor executes search processing of searching for, by executing a simulated conversation between a first agent that simulates a facilitator that supports consensus building in a conversation in a participant group based on a language model and a second agent that simulates participants participating in the conversation based on the language model, a plurality of simulated conversation paths from a start to an end of the simulated conversation, calculation processing of calculating, based on an internal state indicating group recognition for the participant group of the participants in the second agent, an evaluation value for evaluating an utterance of a simulation response sentence in the simulation conversation generated by the second agent in the plurality of simulated conversation paths searched by the search processing, extraction processing of extracting, based on the evaluation value calculated by the calculation processing, a specific simulated utterance candidate sentence from a plurality of simulated utterance candidate sentences from the first agent to the second agent at a start time of the simulated conversation, and output processing of outputting the specific simulated utterance candidate sentence extracted by the extraction processing.

According to the representative embodiment of the invention, it is possible to improve efficiency of consensus building. Problems, configurations, and effects other than those described above will be clarified by descriptions of the following embodiments.

### BRIEF DESCRIPTION OF THE DRAWINGS

FIG. 1 is a diagram showing a system configuration example 1 of a behavior determination system;

FIG. 2 is a block diagram showing a hardware structure example of a computer;

FIG. 3 is a diagram showing an example of a personal information table;

FIG. 4 is a diagram showing an example of a topic information table;

FIG. 5 is a diagram showing an example of a dialogue target information table;

FIG. 6 is a diagram showing an example of a search control information table;

FIG. 7 is a flowchart showing an example of a behavior determination processing procedure performed by a behavior determination device;

FIG. 8 is a diagram showing an example of an internal model of a facilitator agent generated in step S702;

FIG. 9 is a diagram showing an example of an internal model of a participant agent generated in step S702;

FIG. 10 is a flowchart showing an example of a detailed processing procedure of utterance information search processing (step S703);

FIG. 11 is a diagram showing an example of a search tree;

FIG. 12 is a diagram showing graph example 1 of an internal state;

FIG. 13 is a diagram showing graph example 2 of the internal state;

FIG. 14 is a diagram showing screen display example 1 of an utterance result sentence of a facilitator agent;

FIG. 15 is a diagram showing screen display example 2 of the utterance result sentence of the facilitator agent;

FIG. 16 is a diagram showing system configuration example 2 of the behavior determination system; and

FIG. 17 is a diagram showing system configuration example 3 of the behavior determination system.

### DESCRIPTION OF EMBODIMENTS

In embodiments described below, a behavior determination system is provided that utilizes a large-scale language model (LLM) and supports a relationship and consensus building between people. The behavior determination system incorporates an agent that can mitigate a conflict, particularly in a situation in which the “conflict” between people may be problematic. Specifically, for example, the behavior determination system is implemented by incorporating a group cognition model into a free energy principle and an active inference, and by making it an agent (autonomous) by incorporating the active inference into the LLM.

As an application scene of the behavior determination system, 1. conference facilitation (promotion of consensus building among a plurality of participants), and

2. social networking service (SNS) or an online bulletin board are managed (to prevent inappropriate interactions between participants, such as a violent post) are provided. Hereinafter, each embodiment will be described in detail.

### Embodiment 1

### System Configuration Example

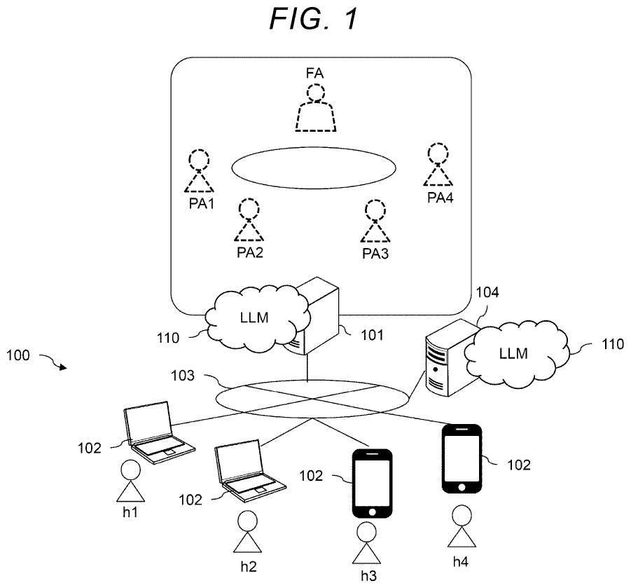

FIG. 1 is a diagram showing system configuration example 1 of a behavior determination system. A behavior determination system 100 includes a behavior determination device 101 serving as a server and one or more terminals 102 (four in FIG. 1 as an example). The behavior determination device 101 and the terminals 102 are communicably connected via a network 103 such as the Internet, a local area network (LAN), or a wide area network (WAN). An external device 104 is also communicably connected to the behavior determination device 101 and the terminals 102 via the network 103.

The behavior determination device 101 and the external device 104 each include an LLM 110. When the LLM 110 of the external device 104 is used, the LLM 110 may not be mounted on the behavior determination device 101.

The LLM 110 is a conversation-type language model subjected to deep learning using a training data set related to a large number of conversations, and can execute various tasks such as a response to a question, correction and summary of a sentence, translation of a sentence, and generation of a sentence. The LLM 110 of the behavior determination device 101 is implemented using, for example, open source software. The LLM 110 of the external device 104 includes, for example, a BERT and a ChatGPT.

The terminals 102 are assigned to participants h1, h2, and so on. When there is no need to distinguish between the participants h1, h2, and so on, they will be referred to as a participant h. The participant h is, for example, a user of the terminal 102 participating in a conversation such as a conference or a chat. In the example of FIG. 1, since the number of terminals 102 is four, the number of participants h is four. Therefore, the number of terminals 102 is equal to the number of participants h. The terminal 102 executes input and output of voice, input and output of a character string, and voice recognition.

The behavior determination device 101 generates a facilitator agent FA as a first agent and participating agents PA1 to PA4 as second agents using the LLM 110. When the participant agents PA1 to PA4 are not distinguished, they are simply referred to as participant agents PA. When the facilitator agent FA and the participant agent PA are not distinguished, they are referred to as agents. The agent is an instance that simulates an utterance of the facilitator or the participant h by converting personal information or an utterance history of each facilitator or participant h into a prompt and inputting the prompt to the LLM 110.

The facilitator agent FA is an agent that simulates an utterance of a facilitator. The facilitator is a virtual conversation leader who makes an utterance to support consensus building in a conversation within a group of the participants h. The participant agent PA is an agent that simulates an utterance of the participant h.

Since the LLM 110 has high versatility, it is possible to simulate the utterance of each agent with the personal information of each agent provided as input information without re-training of each agent. In this case, the facilitator agent FA and the participant agents PA are not subjected to the re-training, but rather simulate the utterance of the facilitator or the participants h by appropriately changing the input information (prompt) corresponding to an instruction to a model. For example, by inputting a prompt such as “You are a university student in the engineering department. What occupation do you want to pursue in the future?” into the LLM 110, the LLM 110 generates, as a response, a character string for each user from a table of personal information, such as “a university student in the engineering department,” in double quotation marks.

An instance is an actual state of a program that generates a prompt for the LLM 110 based on the personal information and the like, inputs the prompt to the LLM 110, and generates a response sentence, like this agent. Since the LLM 110 itself has no state, it can be shared by all agents. Therefore, the LLM 110 itself is not included in the instance. In the actual state, the LLM 110 also consumes a large capacity, so it is not instantiated for each agent. Processing to the LLM 110 is instructed by the shared LLM instance.

The personal information is information unique to a person, such as age, gender, occupation, preference, and value. Specifically, for example, the facilitator agent FA is an agent to which the personal information related to the facilitator is assigned, and the participant agent PA is an agent to which the personal information related to the participant h is assigned. The agent is generated in the behavior determination device 101 regardless of whether the LLM 110 of the behavior determination device 101 is used or the LLM 110 of the external device 104 is used.

That is, the personal information indicating a state of the agent and the utterance history are input to the LLM 110 as the prompt every time. Therefore, there is only one LLM 110, and the LLM 110 may be implemented either inside or outside the behavior determination device 101. When the LLM 110 mounted on the external device 104 is used, the state of the LLM 110 is not stored in the external device 104, and is input as the prompt from the behavior determination device 101 to the external device 104.

In the present example, there is no human facilitator, but by providing certain personal information to the LLM 110 as the prompt, the behavior determination device 101 acts as the facilitator agent FA as if the facilitator is participating in the conversation. The participant h is participating in the conversation, and by giving certain personal information as the prompt to the LLM 110, the behavior determination device 101 acts as the participant agent PA as if it is the participant h.

Specifically, for example, the facilitator agent FA actively determines an utterance to be made by the facilitator in order for the consensus building in the conversation in which the participant h participates, and utters the utterance to the participant h. The utterance is referred to as an utterance in a current conversation state. A plurality of utterances in the current conversation state made by the facilitator agent FA are prepared based on a topic set in advance at the beginning of the conversation, and during the conversation, a plurality of utterances are prepared based on the utterances of the facilitator agent FA in response to the utterances of the participant h. Each utterance of the plurality of prepared utterances of the facilitator agents FA is referred to as a simulated utterance candidate sentence. In order for the facilitator to actively determine the utterance to be made for the consensus building, the participant agent PA responds to the utterance in the current conversation state determined by the facilitator agent FA instead of the participant h.

The behavior determination device 101 generates a search tree by continuing a simulated conversation, which is a virtual conversation of a plurality of patterns branching out from a plurality of simulated utterance candidate sentences starting from the current conversation state, between the facilitator agent FA and the participant agent PA until the discussion converges, and in a search path in which an utterance having the highest evaluation is present, determines a simulated utterance candidate sentence based on the current conversation state as an utterance sentence to be made by the facilitator to promote the conversation (hereinafter, referred to as an utterance result sentence). The behavior determination device 101 transmits the utterance result sentence to the terminal 102. The terminal 102 outputs the information to the participant h so that the information can be visually recognized, or outputs the information through voice by reading it aloud.

Thereafter, when the participant h utters while being promoted by the utterance of the facilitator agent FA, the behavior determination device 101 causes the facilitator agent FA to respond to the utterance of the participant h and updates the current conversation state of the facilitator agent FA. The behavior determination device 101 generates a plurality of simulated utterance candidate sentences based on the updated new current conversation state, thereby re-executing the generation and the search of the search tree, and identification and output of the utterance result sentence, and waits for the utterance of the participant h. The repetition promotes the conversation toward the consensus building.

### Hardware Structure Example of Computer (Behavior Determination Device 101, Terminal 102, and External Device 104)

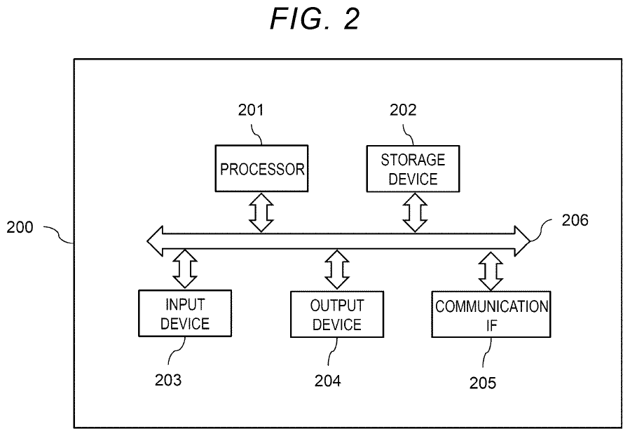

FIG. 2 is a block diagram showing a hardware configuration example of a computer. A computer 200 includes a processor 201, a storage device 202, an input device 203, an output device 204, and a communication interface (communication IF) 205. The processor 201, the storage device 202, the input device 203, the output device 204, and the communication IF 205 are connected by a bus 206. The processor 201 controls the computer 200. The storage device 202 is a work area of the processor 201. In addition, the storage device 202 is a non-transitory or transitory recording medium that stores various programs or data. Examples of the storage device 202 include a read only memory (ROM), a random access memory (RAM), a hard disk drive (HDD), and a flash memory. The input device 203 inputs data. Examples of the input device 203 include a keyboard, a mouse, a touch panel, a numeric keypad, a scanner, a microphone, and a sensor. The output device 204 outputs data. Examples of the output device 204 include a display, a printer, and a speaker. The communication IF 205 is connected to the network 103, and transmits and receives data.

### Personal Information Table

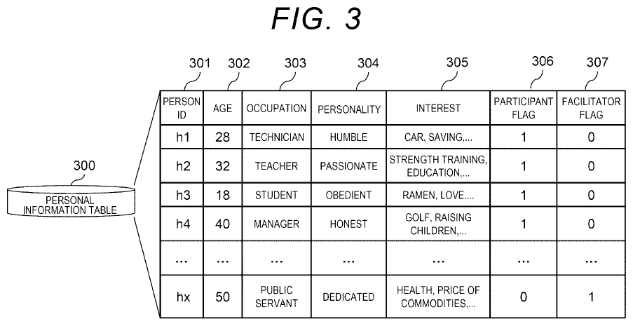

FIG. 3 is a diagram showing an example of the personal information table. A personal information table 300 is stored in the storage device 202 of the behavior determination device 101, for example. The personal information table 300 includes fields of a person ID 301, an age 302, an occupation 303, a personality 304, an interest 305, a participant flag 306, and a facilitator flag 307. A combination of values of the fields in the same row is an entry indicating personal information for identifying one person. The personal information table 300 is not limited thereto and may include other fields such as a date of birth, a gender, and a preference. In addition, the person of the personal information may be an actual person or a virtual person, but since the participant h exists in the conversation, the personal information of the actual person is essential.

The person ID 301 is identification information for uniquely identifying a person. For example, values h1 to h4 of the person ID 301 correspond to the participants h1 to h4, respectively.

The age 302 is a counted value of the number of years that have passed since the date of birth of the person identified by the person ID 301. The age 302 is updated based on a current time measured by a clock in the behavior determination device 101 with reference to the date of birth.

The occupation 303 is a type of a current work to which the person identified by the person ID 301 is engaged or a position equivalent thereto. The occupation 303 can be updated by, for example, directly operating the behavior determination device 101 or indirectly operating the behavior determination device 101 from the terminal 102.

The personality 304 is a combination of mental and moral qualities and features that are unique to the person identified by the person ID 301. The personality 304 can be updated by, for example, directly operating the behavior determination device 101 or indirectly operating the behavior determination device 101 from the terminal 102.

The interest 305 is a word or sentence indicating that the person identified by the person ID 301 is interested in. The interest 305 can be updated by, for example, directly operating the behavior determination device 101 or indirectly operating the behavior determination device 101 from the terminal 102.

The participant flag 306 is an identifier indicating whether the person identified by the person ID 301 is to participate in the conversation. “1” indicates participation, and “0” indicates non-participation. The participant flag 306 can be updated by, for example, directly operating the behavior determination device 101 or indirectly operating the behavior determination device 101 from the terminal 102.

The facilitator flag 307 is an identifier indicating whether the person identified by the person ID 301 is a facilitator of the conversation. If “1” is set, the person identified by the person ID 301 is the facilitator. That is, the facilitator agent FA is generated that converts the personal information of the entry and topic information to be described later into the input information (prompt) to the LLM 110. The facilitator flag 307 can be updated by, for example, the terminal 102 accessing the behavior determination device 101. The facilitator flag 307 can be updated by directly operating the behavior determination device 101 or indirectly operating the behavior determination device 101 from the terminal 102.

### Topic Information Table

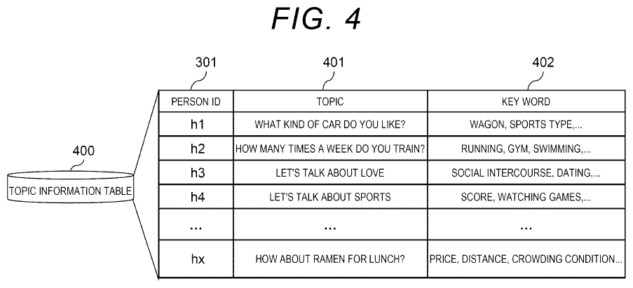

FIG. 4 is a diagram showing an example of a topic information table. A topic information table 400 is stored in the storage device 202 of the behavior determination device 101, for example. The topic information table 400 includes fields of the person ID 301, a topic 401, and a key word 402. A combination of values of the fields in the same row is an entry indicating the topic information.

The topic 401 is a sentence indicating a title of a conversation provided when the person identified by the person ID 301 is a facilitator. The key word 402 is a word related to the topic 401. For example, the facilitator agent FA generates, in the LLM 110, a simulated utterance candidate sentence as an instruction of “Please take the key word 402 (=price, distance, crowding condition) into consideration to generate a sentence for throwing the topic 401 (=how about ramen for lunch?) to the participant h”.

The behavior determination device 101 generates the facilitator agent FA that converts the topic information of the person ID 301 whose facilitator flag 307 is “1” into the input information (prompt) to the LLM 110 together with the personal information.

### Dialogue Target Information Table

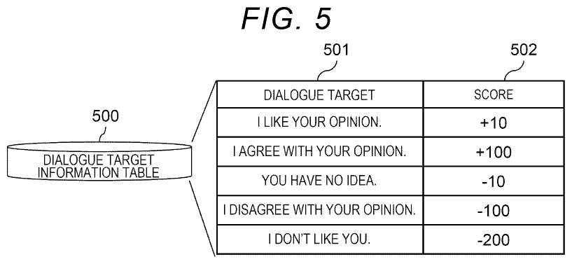

FIG. 5 is a diagram showing an example of a dialogue target information table. A dialogue target information table 500 is stored in, for example, the storage device 202 of the behavior determination device 101. The dialogue target information table 500 includes fields of a dialogue target 501 and a score 502. A combination of values of the fields in the same row is an entry indicating the dialogue target information.

The dialogue target 501 is a word or a sentence indicating a criterion of an evaluation target in a conversation. The score 502 is an evaluation value of the dialogue target 501. For example, in the case of aiming at the consensus building, the score 502 is set as follows. For example, when the dialogue target 501 indicates agreement with an opinion, the value of the score 502 is set high, and when the dialogue target 501 indicates disagreement with the opinion, the value of the score 502 is set lower than when it indicates the agreement. When the dialogue target 501 indicates a favorable utterance toward another participant h, the value of the score 502 is set high, and when the dialogue target 501 indicates an aggressive utterance toward another participant h, the value of the score 502 is set lower than when the dialogue target 501 indicates the favorable utterance.

### Search Control Information Table

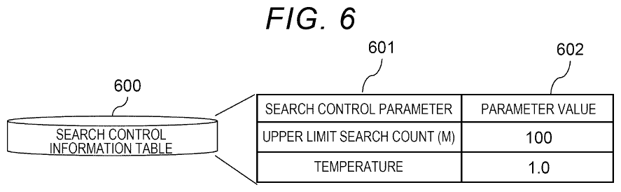

FIG. 6 is a diagram showing an example of a search control information table. A search control information table 600 is stored in, for example, the storage device 202 of the behavior determination device 101. The search control information table 600 includes fields of a search control parameter 601 and a parameter value 602. A combination of values of the fields in the same row is an entry indicating the search control information.

The search control parameter 601 is a parameter for controlling a search tree. The search tree is generated by continuing a simulated conversation of a plurality of patterns until the discussion by the simulated conversation between the agents converges. The search control parameter 601 includes, for example, an upper limit search count and a temperature. The upper limit search count is an upper limit value of the search count of the search tree. The temperature is not an index indicating a degree of hot or cold in a real environment, but an internal parameter for converging the simulated conversation.

The parameter value 602 is a value set as the search control parameter 601. Since the parameter value 602 of a maximum search count is “100”, the search is performed 100 times using the search tree. The parameter value of the temperature 602 is “1.0”. For example, when a conversation is started, a predetermined temperature is set (hereinafter, referred to as a start temperature), and each time a predetermined time elapses, the temperature decreases by “1.0” from the previous temperature. When the updated temperature is equal to or lower than a predetermined threshold value, it is forcibly determined that the conversation is converged. When the start temperature is 40 degrees, the parameter value 602 of the temperature decreases every minute, and when the threshold value is 10 degrees, it is forcibly determined that the conversation is converged in 30 minutes.

### Behavior Determination Processing Procedure

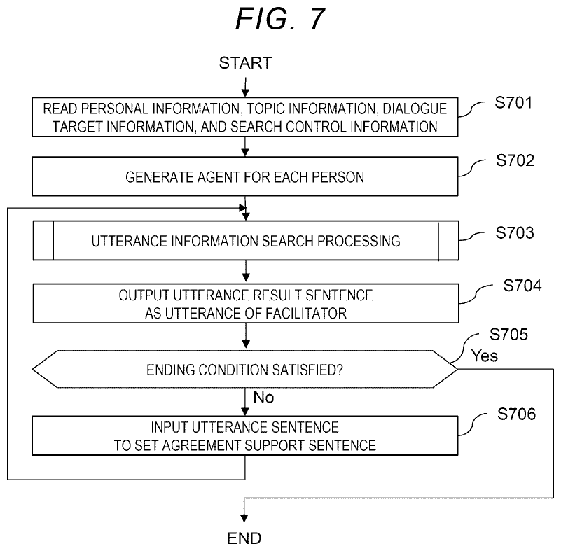

FIG. 7 is a flowchart showing an example of a behavior determination processing procedure performed by the behavior determination device 101.

### Step S701

The behavior determination device 101 reads the personal information, the topic information, the dialogue target information, and the search control information. That is, the behavior determination device 101 reads the entries of the personal information table 300, the topic information table 400, the dialogue target information table 500, and the search control information table 600.

### Step S702

The behavior determination device 101 generates an agent for each person. Specifically, for example, the behavior determination device 101 generates input information (prompt) to the LLM 110 based on the personal information (hereinafter, referred to as facilitator information) in which the facilitator flag 307 is “1” among the personal information acquired in step S701, and inputs the generated prompt to the LLM 110, thereby generating an instance of an agent simulating the facilitator as the facilitator agent FA.

Similarly, the behavior determination device 101 generates input information (prompt) to the LLM 110 based on each piece of personal information (hereinafter, referred to as participant information) in which the participant flag 306 is “1” among the personal information acquired in step S701, and inputs the generated prompt to the LLM 110, thereby generating an instance of an agent simulating each participant h as the participant agent PA.

Accordingly, a multi-agent system is configured by the facilitator agent FA and the participant agent PA.

### Step S703

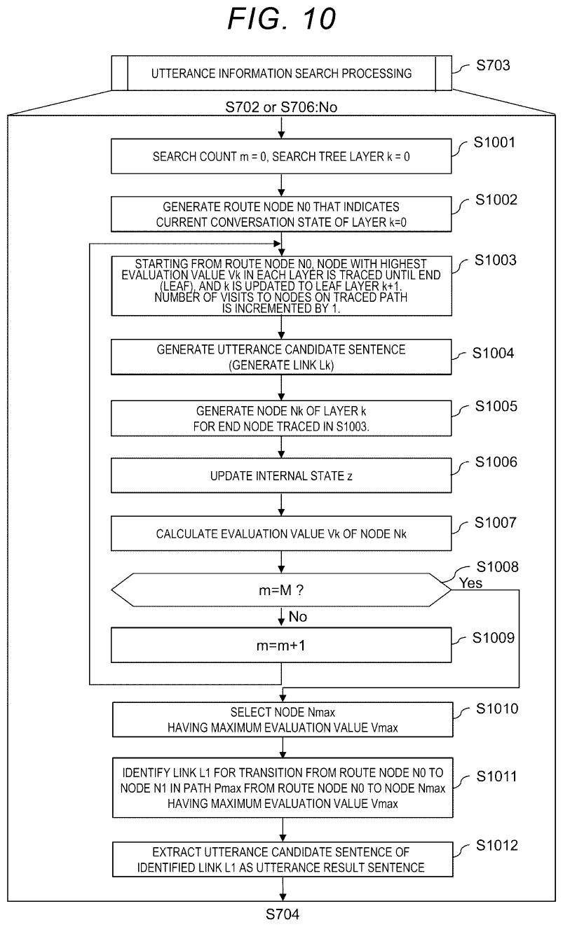

The behavior determination device 101 executes utterance information search processing. The utterance information search processing (step S703) is processing of generating a route node in which the topic 401 of the same person ID 301 as the facilitator information is set in the current conversation state, growing a search tree from the route node in the simulated conversation between the agents, and searching for the grown search tree. Specifically, for example, the behavior determination device 101 performs Monte Carlo tree search processing of growing a Monte Carlo tree from the route node in the simulated conversation between the agents and searching for the grown Monte Carlo tree. Details of the utterance information search processing (step S703) will be described later with reference to FIG. 10. There are various possible configurations for the Monte Carlo tree search, and FIG. 10 shows one example.

### Step S704

The behavior determination device 101 outputs an utterance result sentence obtained in the utterance information search processing (step S703) as an utterance of the facilitator agent FA to the terminal 102 of the participant h so as to allow the participant h to view the utterance result sentence. That is, the behavior determination device 101 transmits voice data of the utterance result sentence to the terminal 102 or transmits text data of the utterance result sentence to the terminal 102. Accordingly, the terminal 102 outputs the utterance result sentence by voice or displays the text data indicating the utterance result sentence.

### Step S705

The behavior determination device 101 determines whether the simulated conversation satisfies an ending condition. When the ending condition is not satisfied (step S705: No), the processing proceeds to step S706. When the ending condition is satisfied (step S705: Yes), the behavior determination device 101 ends the behavior determination processing.

The ending condition is a condition for terminating the simulated conversation. For example, when a preset ending time elapses, the behavior determination device 101 determines that the ending condition is satisfied (step S705: Yes). When a convergence condition of the simulated conversation is satisfied, for example, when an evaluation value of the simulated conversation is equal to or greater than a threshold value, the behavior determination device 101 determines that the conversation is converged (for example, an agreement is made) and determines that the ending condition is satisfied (step S705: Yes). In addition, when the utterance sentence is not input for a certain period of time in step S705, or when the input of the utterance sentence after the certain period of time is continuously detected a predetermined number of times, the behavior determination device 101 may determine that the simulated conversation cannot be continued any further, and determine that the ending condition is satisfied (step S705: Yes).

### Step S706

The behavior determination device 101 receives the input of the utterance sentence of the participant h. Specifically, for example, the terminal 102 converts the utterance of the participant h who views the utterance result sentence into an utterance sentence that is the text data by voice recognition, receives the utterance sentence that is the text data by an operation input of the participant h, and transmits the utterance sentence to the behavior determination device 101. The behavior determination device 101 receives the utterance sentence transmitted from the terminal 102. Then, the behavior determination device 101 inputs the received utterance sentence to the facilitator agent FA, outputs a response sentence thereof, and sets the utterance sentence as a consensus support sentence.

Therefore, in the utterance information search processing (step S703), the consensus support sentence set in step S706 is set as a route node NO indicating the current conversation state, and a search tree 1100 is generated and searched.

### Internal Model of Agent

Next, an internal model of the agent will be described. The agent is configured based on a free energy principle. The free energy principle is a hypothesis of a unified explanation principle for various cognitive functions of an autonomous agent such as a living organism. In the free energy principle, the agent internally holds a model for an environment (a group of the participants h) (hereinafter, referred to as an internal model), and perception, training, and a behavior plan of the agent are defined as processing of minimizing free energy which is an amount representing indeterminism of the model for the environment. That is, the free energy principle is a hypothesis that attempts to provide a unified explanation for various kinds of human cognitive processing, including perception and behavior, by minimizing the free energy. Therefore, the agent is an internal model that models the processing by which an organism subjectively predicts the future of the environment and acts based on the subjective prediction.

The LLM 110 is used as the internal model of the free energy principle. Mathematically, the free energy principle is formulated as variational Bayesian inference, and the internal model is modeled as an instance of the LLM 110.

When observation data (utterance in the present example) from the environment is represented by o and a latent state of the environment is represented by s, a generation model of the environment is represented by P (s, o). The latent state corresponds, for example, to a collection of internal states (emotions, cognitive states toward others) of the participant h or to what might be called an atmosphere of the situation. The agent according to the free energy principle brings the internal model closer to the generation model P (s, o) of the environment as much as possible. In the variational Bayesian inference, the problem is assumed to be a problem of obtaining a probability distribution Q_{θ}(s) that minimizes free energy F defined by the following Formula (1).

[Math. 1]

F=−log P+KLD(Q∥P) (1)

That is, the free energy F is defined by Formula (1) using the generation model P (s, o) of a latent state s of the environment and observation data o, the internal model Q_{θ}(s) determined by a parameter θ approximating the generation model P (s, o) of the latent state s of the environment, and the observation data o. D_{KL}[ ] is a Kullback-Leibler distance, and E[ ] is an expected value. Therefore, the free energy F can be calculated based on the current probability distribution Q and the observation data o.

Formula (2) below represents free energy F_{we} obtained by expanding the free energy principle in the above Formula (1) to a collection including other participants h other than the certain participant h.

$$\begin{matrix}[ Math . 2 ] & \\ {F}_{w e} = {F}_{m y} + {\sum }_{i} {F}_{o t h}^{i} & ( 2 )\end{matrix}$$

In Formula (2), F_{my} is free energy of the certain participant h, and Fₒₜₕⁱ is free energy of another participant h. i is an integer of 1 or more, and is an index for identifying another participant h.

In the above Formula (2), the integrated free energy F_{we} is defined by the following Formula (3) using a weight w indicating a degree of empathy to other persons.

$$\begin{matrix}[ Math . 3 ] & \\ {F}_{w e} = {w}_{m y} {F}_{m y} + {\sum }_{i} ( {z}_{m y} \cdot {z}_{oth}^{i} ) {w}_{o t h}^{i} {F}_{oth}^{i} & ( 3 )\end{matrix}$$

In the above Formula (3), w_{my} is a weight indicating the degree of empathy of the free energy F_{my}, and wₒₜₕⁱ is a weight indicating the degree of empathy of the free energy Fₒₜₕⁱ. When w_{my} and wₒₜₕⁱ are not distinguished from each other, they are simply referred to as w. w is adjusted according to each of change amounts in the free energy F_{my} and the free energy Fₒₜₕⁱ. For example, when one is in the same group as oneself (in-group), w is adjusted to be increased in a positive direction, and conversely, when one is in a different group than oneself (out-group), w is adjusted to be increased in a negative direction.

Z_{my} and zₒₜₕⁱ are internal states output from an encoder 811. An internal state z is a latent vector indicating group recognition for a participant group including the participants h. In the above Formula (3), “z_{my}·zₒₜₕ¹” is an inner product of z_{my} and zₒₜₕⁱ. The smaller the inner product, the more similar the opinion between the participants h.

In the above Formula (3), integrated free energy F_{we-all} an in a case in which each of all the participants h is set as the “certain participant h” is defined by the following Formula (4).

$$\begin{matrix}[ Math . 4 ] & \\ {F}_{we - all} = {\sum }_{j} [ {w}_{m y}^{j} \cdot {F}_{m y}^{j} + {\sum }_{i} ( {z}_{m y}^{j} \cdot {z}_{o t h}^{i} ) {w}_{oth}^{j} {F}_{o t h}^{i} ] & ( 4 )\end{matrix}$$

j is an integer of 1 or more, and is an index for identifying each of the participants h. The description returns to the internal model.

### Internal Model of Facilitator Agent FA

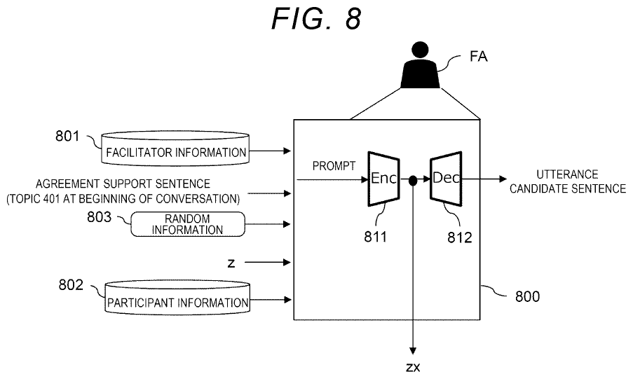

FIG. 8 is a diagram showing an example of the internal model of the facilitator agent FA generated in step S702. An internal model 800 of the facilitator agent FA is the LLM 110 including the encoder 811 and a decoder 812. Facilitator information 801 is vectorized personal information in which the facilitator flag 307 is “1”. When the facilitator information 801 is input, the facilitator agent FA is generated as an instance unique to the facilitator.

The internal model 800 adopts a probability sampling method (reparameterization trick) used in a variational auto-encoder (VAE), and probablistically samples the latent state s. That is, the internal model 800 is a model that probablistically outputs the latent state s in the future based on the current latent state s. The same applies to the internal model 800 of the participant agent PA.

In the utterance information search processing (step S703), the facilitator agent FA generates a prompt based on the consensus support sentence (the topic 401 at the beginning), participant information 802, an internal state zp of each of the participant agents PA, and random information 803, and inputs the prompt to the internal model 800. The consensus support sentence is a sentence that supports consensus building between the participant agents PA. The internal state zp of the participant agent PA corresponds to the internal state z_{my} and the internal state zₒₜₕⁱ.

The facilitator agent FA outputs its own internal state zx from the encoder 811. The facilitator agent FA inputs the internal state zx to the decoder 812 and outputs a simulated utterance candidate sentence. When the internal states zp and zx are not distinguished, they are denoted by z. The internal state z is vector information that indicates an inner state of a person that the agent simulates.

The internal state zp is used to identify an utterance partner who the facilitator agent FA utters the simulated utterance candidate sentence, that is, the participating agent PA to which the simulated utterance candidate sentence is input. For example, among the participant agents PA, two participant agents PA having the longest inter-vector distance of the internal state zp are set as the utterance partners who utter the simulated utterance candidate sentence. Accordingly, the simulation response sentence from the participating agent PA of the utterance partner can be guided so that the inter-vector distance of the internal state zp is shortened.

The behavior determination device 101 may narrow down the utterance partners who utter the simulated utterance candidate sentence with reference to the word or the key word 402 in the topic 401. For example, when “swimming” is included in a certain simulated utterance candidate sentence, the behavior determination device 101 identifies “h2” as the person ID 301 including “swimming” in the key word 402 from the topic information table 400. In addition, the behavior determination device 101 identifies “h1”, “h3”, and “h4” as the person ID 301 that does not include “swimming” in the key word 402 from the topic information table 400.

The behavior determination device 101 sets a combination of the participant agents PA having the longest inter-vector distance (for example, the participant agents PA2 and PA4) among an inter-vector distance between the internal state zp2 output by the participant agent PA2 of the participant h2 and an internal state zp1 output by the participant agent PA1 of the participant h1, an inter-vector distance between an internal state zp2 and an internal state zp3 output by the participant agent PA3 of the participant h3, and an inter-vector distance between the internal state zp2 and an internal state zp4 output by the participant agent PA4 of the participant h4, as the utterance partner who utters the simulated utterance candidate sentence.

Accordingly, the simulation response sentence from the participating agent PA of the utterance partner can be efficiently guided so that the inter-vector distance of the internal state zp is shortened.

The participant information 802 is personal information of the participant agent PA that is the utterance partner who utters the simulated utterance candidate sentence. One or more combinations of the utterance partners who utter the simulated utterance candidate sentence can be set. The facilitator agent FA generates the simulated utterance candidate sentence for each of the combinations of the utterance partners who utter the simulated utterance candidate sentence.

The internal state zx may be included in the internal state zp. In this case, the facilitator agent FA is set as the utterance partner who utters the simulated utterance candidate sentence by the participant agent PA who outputs the internal state zp having the longest distance from the internal state zx.

The random information 803 is a parameter for controlling randomness of utterance. Specifically, for example, the random information 803 is a parameter that gives a random addition or subtraction to the generation of the consensus support sentence by the facilitator agent FA, and examples thereof include “temperature” and “top P”. For example, in the case of the “temperature”, the random information 803 takes a range of 0.0 to 2.0. The smaller the value of the random information 803, the smaller the randomness of the simulated utterance candidate sentence output from the decoder 812.

The larger the value of the random information 803, the larger the randomness of the simulated utterance candidate sentence output from the decoder 812, and the larger the change in an expression of the consensus support sentence input to the encoder 811. The value of the random information 803 can be set to one or more, and is set before an item of the utterance information search processing (step S703) is started. The facilitator agent FA generates the simulated utterance candidate sentence for each value of the random information 803.

By setting a plurality of values of the random information 803 for each combination of the utterance partners who utter the simulated utterance candidate sentences, the facilitator agent FA generates the simulated utterance candidate sentence for each combination of the utterance partners who utter the simulated utterance candidate sentences for each value of the random information 803. In addition to the temperature, the simulated utterance candidate sentence is generated according to a predetermined generation rule. For example, the simulated utterance candidate sentence is generated according to a generation rule such as “an opinion that everyone most agrees on for the combination of the utterance partners”.

### Internal Model of Participant Agent PA

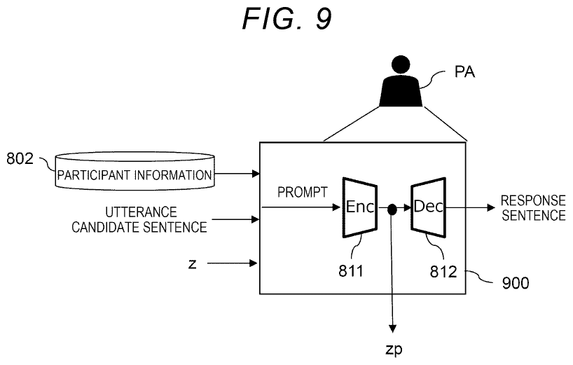

FIG. 9 is a diagram showing an example of the internal model of the participant agent PA generated in step S702. Similarly to the internal model 800 of the facilitator agent FA, an internal model 900 of the participant agent PA is the LLM 110 including the encoder 811 and the decoder 812. The participant information 802 is vectorized personal information in which the participant flag 306 is “1”. When the participant information 802 is input, the participant agent PA is generated as an instance unique to the participant h.

In the utterance information search processing (step S703), the participant agent PA inputs the simulated utterance candidate sentence from the facilitator agent FA. The participant agent PA outputs its own internal state zp from the encoder 811. The participant agent PA inputs the internal state zp to the decoder 812 and outputs a simulation response sentence corresponding to the simulated utterance candidate sentence.

When the agent is executed using the LLM 110 of the behavior determination device 101, the behavior determination device 101 acquires the internal state z from the encoder 811 of the agent. When the agent is executed using the LLM 110 of the external device 104, the behavior determination device 101 requests the internal state z from each agent of the external device 104, and the external device 104 acquires the internal state z output from the encoder 811 of each agent in response to the request via the network 103.

Unless re-training is performed for each agent, the internal models 800 and 900 (LLM 110) themselves are actually shared by all of the agents.

### Utterance Information Search Processing (Step S703)

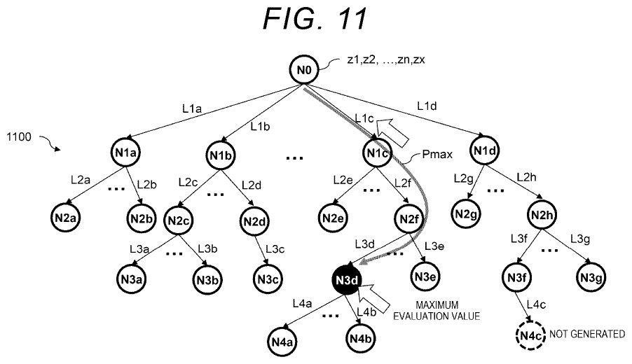

FIG. 10 is a flowchart showing an example of a detailed processing procedure of the utterance information search processing (step S703). FIG. 11 is a diagram showing an example of the search tree.

### Step S1001

The behavior determination device 101 initializes a search count m to m=1, and initializes a layer k of the search tree 1100 to be generated and searched to k=1. m is an integer of 1 or more, and k is an integer of 0 or more.

### Step S1002

The behavior determination device 101 generates the node NO indicating a conversation state of the layer k=0. When the layer k=0, the conversation state indicated by the node NO is the current conversation state. The node NO is referred to as a route node of the search tree 1100. In the route node NO, the topic 401 of the facilitator (the person ID 301=hx) obtained from the topic information table 400 in step S701, that is, “How about ramen for lunch?”, is set as the consensus support sentence.

### Step S1003

In the search tree 1100 currently being generated, the behavior determination device 101 traces a link Lk from the route node NO to a node Nk having the highest evaluation value Vk in each layer k to the node Nk (leaf) at the end, and updates the current layer k based on the layer of the leaf that has been traced.

For example, since there is only the route node NO in the initial state, the route node NO itself becomes a leaf to be traced, the layer k=0 is incremented to the layer k=1, and the processing proceeds to step S1004.

For example, as shown in the search tree 1100 of FIG. 11, when a node N4c is not generated and all the other nodes are generated, it is assumed that a node N3f is reached as a result of tracing the node having the highest evaluation value in each layer. In this case, since the node N3f is the node at the end and the layer k thereof is k=3, the layer k=3 is incremented and the layer k is updated to k=4. In this case, in step S1004, a link L4c of the updated layer k=4 is generated, and in step S1005, the node N4c of the updated layer k=4 is generated.

The number of visits is set for all the nodes Nk in the search tree 1100 currently being generated. An initial value of the number of visits is 0. The number of visits of the node Nk on the path to the leaf node Nk via the node Nk having the highest evaluation value Vk is increased by 1. The number of visits of the node Nk is used to correct the evaluation value Vk. A direction in which the layer k is increased is a direction in which the link Lk and the node Nk are generated and the search tree 1100 grows. That is, it is the direction in which a simulated conversation between the facilitator agent FA (simulated utterance candidate sentence) and the participant agent PA (simulation response sentence for the simulated utterance candidate sentence) progresses.

### Step S1004: Generation of Link Lk

The behavior determination device 101 sets a leaf node traced in step S1003 as the node Nk and generates one or more links Lk connected to the node Nk. Taking the layer k=1 as an example, the behavior determination device 101 selects an utterance partner of a simulated utterance candidate sentence of the facilitator agent FA from a group of the participant agents PA.

In the layer k=1, each participant agent PA does not calculate the internal state zp. Therefore, the behavior determination device 101 determines the utterance partners of the simulated utterance candidate sentences to be the combination of one or more participant agents PA set in advance (for example, all of the participant agents PA1 to PAn). Here, for example, the random information 803 has four values, namely, “0.1”, “0.5”, “1.0”, and “2.0”, and the number of combinations of the utterance partners of the simulated utterance candidate sentence is one, which is “all of the participant agents PA1 to PA4”.

The number of links L(k+1) output from a certain node Nk is the number of values of the random information 803×the number of combinations of the utterance partners of the simulated utterance candidate sentence. For example, in the case of the link L1, when the value of the random information 803 is four, namely, “0.1”, “0.5”, “1.0”, and “2.0” and the number of combinations of the utterance partners of the simulated utterance candidate sentence is one, which is “all of the participant agents PA1 to PA4”, the number of links L1 is four (hereinafter, referred to as links L1a, L1b, L1c, and L1d).

The behavior determination device 101 sets the random information 803 and the combination of the utterance partners of the simulated utterance candidate sentences in the facilitator agent FA. When the behavior determination device 101 inputs the topic 401, that is “How about ramen for lunch?”, to the facilitator agent FA, the facilitator agent FA generates the simulated utterance candidate sentence for each of the links L1a, L1b, L1c, and L1d to “all of the participant agents PA1 to PA4”.

For example, the link L1a indicates a simulated utterance candidate sentence based on the value “0.0” of the random information 803 (for example, the topic 401 as is). The link L1b indicates a simulated utterance candidate sentence based on the value “0.5” of the random information 803 (for example, “How about noodles for lunch?”). The link L1c indicates a simulated utterance candidate sentence based on the value “1.0” of the random information 803 (for example, “What kind of instant noodles do you like?”). The link L1d indicates a simulated utterance candidate sentence based on the value “2.0” of the random information 803 (for example, what is a favorite food?).

When the layer k≥2, the participant agent PA has the latest internal state zp. In this case, as described above, the behavior determination device 101 determines the utterance partner of the simulated utterance candidate sentence based on the internal state zp for each simulated utterance candidate sentence.

In the following example, as shown in FIG. 11, a case in which links L2a to L2h are generated in the layer k=2, links L3a to L3g are generated in the layer k=3, and links L4a to L4c are generated in the layer k=4 will be described. The link Lk is not generated under a certain condition, for example, when there is no participant agent PA as the simulated utterance candidate sentence, or when the evaluation value Vk of a node exceeds a threshold value.

### Step S1005: Generation of Node Nk

The behavior determination device 101 generates the node Nk indicating the conversation state of the layer k for the leaf node traced in step S1003. The number of visits of the node Nk at the time of generation is 0. Specifically, for example, the behavior determination device 101 inputs the simulated utterance candidate sentence from the facilitator agent FA to the participant agent PA of the utterance partner of the simulated utterance candidate sentence. The participant agent PA generates the simulation response sentence for the simulated utterance candidate sentence. Taking the link L1 as an example, the behavior determination device 101 inputs the simulated utterance candidate sentences of the links L1a to L1d to the participant agent PA of the utterance partner of the simulated utterance candidate sentence.

For example, in the above example, the utterance partners of the simulated utterance candidate sentence are “all of the participant agents PA1 to PA4”. Therefore, the behavior determination device 101 inputs the simulated utterance candidate sentence of the link L1a to each of the participant agents PA1 to PA4, inputs the simulated utterance candidate sentence of the link L1b to each of the participant agents PA1 to PA4, inputs the simulated utterance candidate sentence of the link L1c to each of the participant agents PA1 to PA4, and inputs the simulated utterance candidate sentence of the link L1d to each of the participant agents PA1 to PA4.

The behavior determination device 101 acquires the simulation response sentence and the internal state zp output from the participant agent PA. For example, in the above example, each of the participant agents PA1 to PA4 generates the simulation response sentence in response to the simulated utterance candidate sentence of the link L1a, and acquires the internal states zp1 to zp4 output from the encoders 811 of each of the participant agents PA1 to PA4. The four simulation response sentences and the internal states zp1 to zp4 become the node N1a connected to the link L1a.

Similarly, regarding the simulated utterance candidate sentences of the link L1b to the link L1d, each of the participant agents PA1 to PA4 generates the simulation response sentence, and acquires the internal states zp1 to zp4 output from the encoders 811 of each of the participant agents PA1 to PA4. Accordingly, the node N1b to the node N1d connected to the link L1b to the link L1d are generated.

As shown in FIG. 11, nodes N2a to N2h connected to the links L2a to L2h are generated in the layer k=2, nodes N3a to N3g connected to the links L3a to L3g are generated in the layer k=3, and nodes N4a to N4c connected to the links L4a to L4c are generated in the layer k=4.

In the search tree 1100, a path from the route node NO indicating the current conversation state to each of the nodes N2a, N2b, N3a, N3b, N3c, N2e, N4a, N4b, N3e, N4c, and N3g at the end is referred to as a simulated conversation path.

### Step S1006: Update of Internal State zp

The behavior determination device 101 updates the internal state z of a layer (k−1) to the internal state z of the layer k. In the case of the layer k=1, since there is no internal state z of the layer k=0, the internal state z of the layer k=1 is set. Specifically, for example, in the layer k=1, the behavior determination device 101 sets the internal states zp1 to zp4 generated by the link L1a to a newly generated node N1a of the layer k=1. Similarly, for the nodes N1b to N1d, the behavior determination device 101 sets the internal states zp1 to zp4 generated in the link L1b to link L1d, respectively.

As shown in FIG. 11, the internal states zp1 to zp4 of the nodes N2a to N2h are updated in the layer k=2, the internal states zp1 to zp4 of the nodes N3a to N3g connected to the links L3a to L3g are updated in the layer k=3, and the internal states zp1 to zp4 of the nodes N4a to N4c connected to the links L4a to L4c are updated in the layer k=4.

### Step S1007: Calculation of Evaluation Value Vk

The behavior determination device 101 calculates the evaluation value Vk of the node Nk. The evaluation value Vk is an index indicating whether the conversation state indicated by the node Nk is toward the consensus building, and a higher value indicates that the conversation state is toward the consensus building. Specifically, for example, in the layer k=1, the behavior determination device 101 calculates evaluation values V1a to V1d for each of the nodes N1a to N1d. In the layer k=2, the behavior determination device 101 calculates evaluation values V2a to V2h for each of the nodes N2a to N2h. In the layer k=3, the behavior determination device 101 calculates evaluation values V3a to V3g for each of the nodes N3a to N3g. In the layer k=4, the behavior determination device 101 calculates evaluation values V4a to V4c for each of the nodes N4a to N4c. The calculation of the evaluation value Vk will be described later.

### Step S1008

The behavior determination device 101 determines whether the search count m reaches an upper limit search count M. When the search count m does not reach the upper limit search count M (step S1008: No), the processing proceeds to step S1009. When the search count m reaches the upper limit search count M (step S1008: Yes), the processing proceeds to step S1010.

### Step S1009

The behavior determination device 101 increments the search count m and returns the processing to step S1003.

### Step S1010

The behavior determination device 101 selects a node Nmax having a maximum evaluation value Vmax from the search tree 1100. In the example of FIG. 11, it is assumed that the evaluation value V3d of the node N3d is the maximum evaluation value Vmax. The behavior determination device 101 may select not only the node Nmax having the maximum evaluation value Vmax from the search tree 1100 but also the nodes Nk up to the top n-th (n is an integer of 1 or more) nodes in descending order of the evaluation values Vk. The behavior determination device 101 may select the node Nk whose evaluation value Vk is equal to or greater than a threshold value. In any case, when a plurality of nodes Nk are selected, the behavior determination device 101 selects any one of the plurality of selected nodes Nk.

### Step S1011

The behavior determination device 101 identifies the link L1 for transition from the route node NO to the node N1 in a path Pmax from the route node NO to a node Nmax having the maximum evaluation value Vmax. In the case of the search tree 1100 of FIG. 11, the path Pmax is a path passing through the route node NO, the link L1c, the node N1c, the link L2f, the node N2f, the link L3d, and the node N3d. The link L1 for transition from the route node NO to the node N1c is the link L1c.

### Step S1012

The behavior determination device 101 extracts the simulated utterance candidate sentence of the link L1c identified in step S1011 as an utterance result sentence, and the processing proceeds to step S704. Accordingly, the behavior determination device 101 can output the simulated utterance candidate sentence of the link L1c extracted in step S1012 as the utterance result sentence to the terminal 102 in a viewable manner (step S704). Specifically, for example, the terminal 102 displays a simulated utterance candidate sentence on a display screen or reads out the simulated utterance candidate sentence and performs voice output. The terminal 102 executes at least one of the display and the voice output.

Thereafter, as described above, the behavior determination device 101 receives the input of the utterance sentence from the participants h1 to h4 who view the utterance result sentence from the terminal 102 (step S705), and re-executes the utterance information search processing (step S703). In this case, the facilitator agent FA inputs the utterance sentences from the participants h1 to h4, and outputs a response sentence for supporting the consensus building as the consensus support sentence. The behavior determination device 101 generates the response sentence instead of the topic 401 as the route node NO indicating the current conversation state of the layer k=0 (step S1002).

Accordingly, the behavior determination device 101 can configure a multi-agent (the facilitator agent FA and the participant agent PA), and can realize the determination of an active utterance result sentence of the facilitator agent FA supporting the consensus building using the virtual simulated utterance candidate sentence generated based on the participant agent PA.

Calculation of Evaluation Value Vk (step S1007) Next, the calculation of the evaluation value Vk (step S1007) will be specifically described. The behavior determination device 101 calculates the evaluation value Vk by using integrated free energy F_{we-all} of the above-described Formula (4) and the dialogue target information table 500. The participant agent PA for which the evaluation value Vk is to be calculated may be assumed to be all the participants h, or may be limited to the participant agent PA that is the utterance partner of the simulated utterance candidate sentence identified by the node Nk. The subsequent evaluation value Vk is corrected by the number of visits of the node. For example, when the number of visits of the node is n, the value is corrected by Formula (5).

$$\begin{matrix}[ Math . 5 ] & \\ {V}_{k} = \frac{{V}_{k}}{n} + \frac{\sqrt{2 ln ( m )}}{n} & ( 5 )\end{matrix}$$

### When Integrated Free Energy F_{we-all} is Used

For example, when the LLM 110 is implemented in the external device 104, the behavior determination device 101 calculates the evaluation value Vk based on the integrated free energy F_{we-all} for each node Nk (excluding the route node NO). As the value of the integrated free energy F_{we-all} decreases, indeterminism of prediction decreases, and thus the evaluation value Vk increases.

As described above, the behavior determination device 101 can promote a conversation with reduced indeterminism of prediction by using the integrated free energy F_{we-all}.

When Internal State zp between Participant Agents PA is Used The behavior determination device 101 may calculate the evaluation value Vk using the internal state zp between the participant agents PA without using the integrated free energy F_{we-all}.

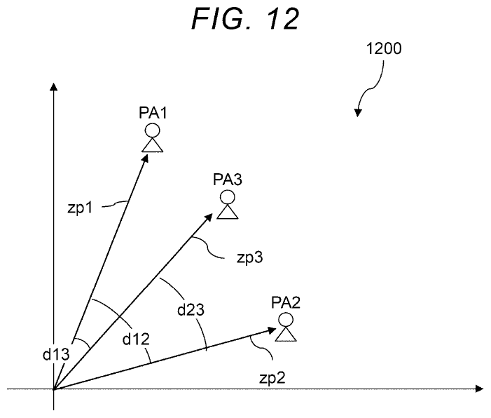

FIG. 12 is a diagram showing graph example 1 of the internal state zp. In FIG. 12, for convenience of description, the internal states zp1 to zp3 of the participant agents PA1 to PA3 are shown in a vector space 1200. In the case of the present example, the smaller the sum of an inter-vector distance d12 between the internal states zp1 and zp2, an inter-vector distance d23 between the internal states zp2 and zp3, and an inter-vector distance d13 between the internal states zp1 and zp3, the closer the internal state of each participant h is, and it is considered that there is a high possibility of reaching an agreement. Therefore, the behavior determination device 101 increases the evaluation value Vk as the sum of the inter-vector distances decreases. For example, the behavior determination device 101 sets an inverse of the sum of the inter-vector distances (a positive value may be added so that the denominator is always greater than 0) as the evaluation value Vk.

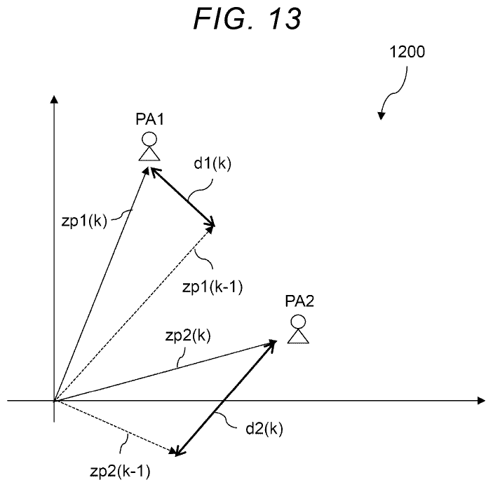

FIG. 13 is a diagram showing graph example 2 of the internal state z. In FIG. 13, for convenience of description, the internal states zp1 and zp2 of the participant agents PA1 and PA2 are shown in the vector space 1200. An internal state zp1 (k−1) is the internal state zp1 output from the participant agent PA1 at the node N (k−1) of the layer (k−1) of the search tree 1100, and the internal state zp1 (k) is the internal state zp1 output from the participant agent PA1 at the node N (k) of the layer k of the search tree 1100. The same applies to internal states zp2 (k−1) and zp2 (k).

Change amounts in a progress direction of the simulated conversation from the layer (k−1) to the layer k are represented by d1 (k) and d2 (k). The change amount d1 (k) is an inter-vector distance between the internal state zp1 (k−1) and the internal state zp1 (k), and the change amount d2 (k) is the inter-vector distance between the internal state zp2 (k−1) and the internal state zp2 (k). That is, the change amounts d1 (k) and d2 (k) are the inter-vector distances of the internal state z before and after the update in step S1006.

It is considered that as the sum of the change amounts d1(k) and d2 (k) is larger, the internal state is changed and the possibility that the discussion is activated is high. Therefore, the behavior determination device 101 increases the evaluation value Vk as the sum of the inter-vector distances increases. For example, the behavior determination device 101 sets the sum of the inter-vector distances as the evaluation value Vk.

As described above, by using the internal state z, the behavior determination device 101 can support the consensus building according to the indeterminism of prediction, the closeness of the internal state between the participants h, and an activity degree of a discussion state.

Although the internal state zp of the participant agent PA is applied to the determination of the utterance partner of the simulated utterance candidate sentence and the calculation of the evaluation value Vk, the internal state zx of the facilitator agent FA may also be included. For example, in determining the utterance partner of the simulated utterance candidate sentence, the behavior determination device 101 may determine the participant agent PA having the longest inter-vector distance between the internal state zx and the internal state zp as the utterance partner of the simulated utterance candidate sentence. Accordingly, the determination of the utterance partner of the simulated utterance candidate sentence and the calculation of the evaluation value Vk can be executed in consideration of a standing position of the facilitator agent FA, and comparing to a case in which the internal state zx of the facilitator agent FA is not included, the consensus building is more efficient.

In any of the case of using the integrated free energy F_{we-all} and the case of using the internal state z between all the participant agents PA as described above, the behavior determination device 101 may adjust the evaluation value Vk using the dialogue target information table 500.

For example, the behavior determination device 101 vectorizes the simulation response sentence of the participant agent PA of the node Nk and the dialogue target 501 by a vectorization method such as doc2vec, and calculates the inter-vector distance. The behavior determination device 101 calculates a weighted linear sum by multiplying each inter-vector distance by the score 502 corresponding to the dialogue target 501, and adds the weighted linear sum to the evaluation value Vk.

In this way, by adding, to the evaluation value Vk, the weighted linear sum using the inter-vector distance from the dialogue target 501, it is possible to promote a conversation with reduced indeterminism of prediction to approach the dialogue target 501.

### Screen Display Example

Next, a screen display example of the utterance result sentence of the facilitator agent FA output in the utterance information search processing (step S703) will be described.

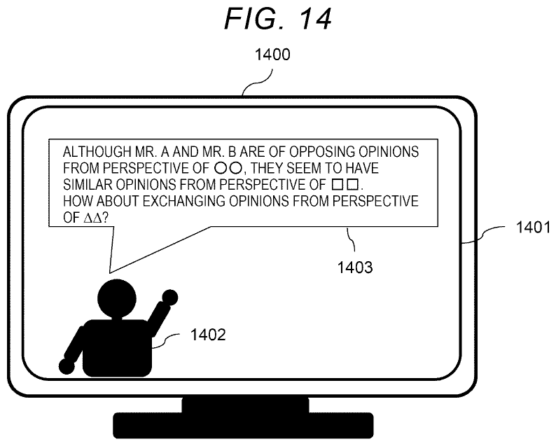

FIG. 14 is a diagram showing screen display example 1 of the utterance result sentence of the facilitator agent FA. A display device 1400 is an example of the output device 204 of the terminal 102. The display device 1400 displays, on a display screen 1401, an avatar 1402 of a facilitator virtually existing by the facilitator agent FA and an utterance result sentence 1403 of the facilitator agent FA output in the utterance information search processing (step S703). The behavior determination device 101 may output the utterance result sentence 1403 by voice from a speaker which is an example of the output device 204.

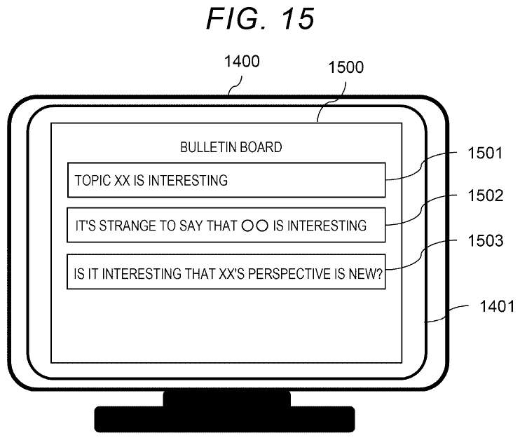

FIG. 15 is a diagram showing screen display example 2 of the utterance result sentence of the facilitator agent FA. The display device 1400 displays a bulletin board 1500 on the display screen 1401. On the bulletin board 1500, an utterance result sentence 1501 of the facilitator agent FA output in the utterance information search processing (step S703), an utterance sentence 1502 of the participant h who responds to the utterance result sentence 1501 in step S705, and an utterance result sentence 1503 of the facilitator agent FA output in the utterance information search processing (step S703) again according to the utterance sentence 1502 are displayed in time series. The behavior determination device 101 may output the utterance result sentence 1501, the utterance sentence 1502, and the utterance result sentence 1503 by voice from a speaker which is an example of the output device 204.

As described above, according to Embodiment 1, in a conversation in which no facilitator exists, the facilitator agent FA can determine an utterance to be made by the facilitator to promote the conversation in the conversation in which the participant h participates, without the need for training using facilitation behavior data to be collected at the time of execution, and utter to the participant h. Accordingly, it is possible to improve efficiency of the consensus building.

### Embodiment 2

Embodiment 2 will be described. In Embodiment 1 described above, the system configuration in which each participant h uses the terminal 102 of the participant h is described as an example, and in Embodiment 2, a case in which no terminal 102 exists is described as an example. In Embodiment 2, since differences from Embodiment 1 will be mainly described, the parts same as those in Embodiment 1 are denoted by the same signs, and the description thereof will be omitted.

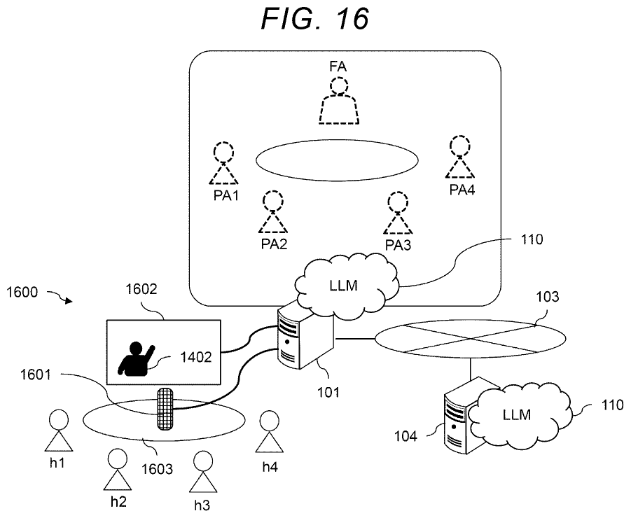

FIG. 16 is a diagram showing system configuration example 2 of the behavior determination system. The behavior determination system 100 includes the behavior determination device 101, a microphone 1601, and a display device 1602. The microphone 1601 and the display device 1602 are connected to the behavior determination device 101.

The microphone 1601 is an example of the input device 203 of the behavior determination device 101. The microphone 1601 is provided, for example, on a table 1603 surrounded by the participants h, receives utterance voice from the participants h, and outputs voice data to the behavior determination device 101. The display device 1602 is an example of the output device 204 of the behavior determination device 101. The display device 1602 performs the display same as that of the display device 1400 of the terminal 102 shown in FIGS. 14 and 15. As described with reference to FIGS. 14 and 15, the behavior determination device 101 may output the utterance sentence of a display content by voice.

The behavior determination device 101 holds sample voice data of the participant h in advance, and recognizes, using existing voice recognition, which participant h utters based on the voice data from the microphone 1601 and the sample voice data. The microphone 1601 may be prepared for each participant h. In this case, since the participant h corresponds to each microphone, it is easy to recognize which participant h utters.

As described above, also in the system configuration shown in FIG. 16, as in Embodiment 1, in a conversation in which no facilitator exists, the facilitator agent FA can actively determine an utterance to be made by the facilitator to promote the conversation in the conversation in which the participant h participates, and can utter to the participant h. Accordingly, it is possible to improve efficiency of the consensus building.

### Embodiment 3

Embodiment 3 will be described. In Embodiment 1 and Embodiment 2 described above, the case in which the facilitator agent FA is one for all the participant agents PA is described as an example, and in Embodiment 3, the facilitator agent FA is implemented for each participant agent PA. In Embodiment 3, differences from Embodiment 1 and Embodiment 2 are mainly described. Therefore, the same parts as those in Embodiment 1 and Embodiment 2 are denoted by the same reference numerals, and the description thereof will be omitted.

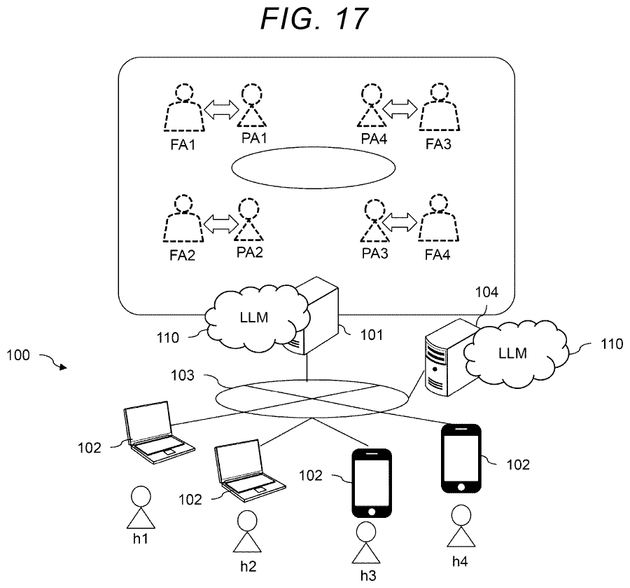

FIG. 17 is a diagram showing a system configuration example 3 of the behavior determination system 100. In the behavior determination device 101, facilitator agents FA1 to FA4 are implemented for each of the participant agents PA1 to PA4. In this case, the behavior determination device 101 executes the processing shown in FIGS. 7 and 10 for each of the facilitator agents FA1 to FA4.

That is, the behavior determination device 101 repeats the processing of executing the utterance information search processing (step S703) between the facilitator agent FA1 and the participant agent PA1, outputting the utterance result sentence to the participant h1 in a viewable manner, and inputting the utterance sentence from the participant h1 (step S705). Similarly, the behavior determination device 101 repeats the processing of executing the utterance information search processing (step S703) between the facilitator agent FA2 and the participant agent PA2, outputting the utterance result sentence to the participant h2 in a viewable manner, and inputting the utterance sentence from the participant h2 (step S705). The same applies to a relationship between facilitator agent FA3 and participant agent PA3, and between facilitator agent FA4 and participant agent PA4.

As described above, in Embodiment 3, since the facilitator agent FA is implemented for each participant agent PA, each facilitator agent FA can actively make an utterance to promote the utterance of the participant h.

Although the one facilitator agent FA is implemented for one participant agent PA, the one facilitator agent FA may be implemented for a plurality of participant agents PA. For example, the facilitator agent FA1 may be implemented for the participant agents PA1 to PA3, and the facilitator agent FA4 may be implemented for the participant agent PA4.

In FIG. 17, the system configuration of FIG. 1 in Embodiment 1 is described as an example, but the same applies to the system configuration of FIG. 16 in Embodiment 2.

The invention is not limited to the above embodiments, and includes various modifications and equivalent configurations within the scope of the appended claims. For example, the above embodiment is described in detail for easy understanding of the invention, and the invention is not necessarily limited to those including all the configurations described above. A part of a configuration of one embodiment may be replaced with a configuration of another embodiment. A configuration of one embodiment may also be added to a configuration of another embodiment. Another configuration may be added to a part of a configuration of each embodiment, and a part of the configuration of each embodiment may be deleted or replaced with another configuration.

A part or all of the above configurations, functions, processing units, processing methods, and the like may be implemented by hardware by, for example, designing with an integrated circuit, or may be implemented by software by, for example, a processor interpreting and executing a program for implementing each function.

Information on such as a program, a table, and a file for implementing each function can be stored in a storage device such as a memory, a hard disk, or a solid state drive (SSD), or in a recording medium such as an integrated circuit (IC) card, an SD card, or a digital versatile disc (DVD).

Control lines and information lines considered to be necessary for description are shown, and not all control lines and information lines necessary for implementation are shown. Actually, it may be considered that almost all the configurations are connected to one another.

What is claimed is:

1. A behavior determination device comprising:
a processor configured to execute a program; and
a storage device configured to store the program, wherein
the processor executes
search processing of searching for, by executing a simulated conversation between a first agent that simulates a facilitator that supports consensus building in a conversation in a participant group based on a language model and a second agent that simulates participants participating in the conversation based on the language model, a plurality of simulated conversation paths from a start to an end of the simulated conversation,
calculation processing of calculating, based on an internal state indicating group recognition for the participant group of the participants in the second agent, an evaluation value for evaluating an utterance of a simulation response sentence in the simulation conversation generated by the second agent in the plurality of simulated conversation paths searched by the search processing,
extraction processing of extracting, based on the evaluation value calculated by the calculation processing, a specific simulated utterance candidate sentence from a plurality of simulated utterance candidate sentences from the first agent to the second agent at a start time of the simulated conversation, and
output processing of outputting the specific simulated utterance candidate sentence extracted by the extraction processing.

2. The behavior determination device according to claim 1, wherein
in the search processing, the processor repeatedly executes, as the simulated conversation, first generation of generating a plurality of simulated utterance candidate sentences by inputting to the first agent a consensus support sentence for supporting the consensus building of the conversation, and second generation of generating, as the consensus support sentence, a simulation response sentence for the simulated utterance candidate sentences by inputting the simulated utterance candidate sentences to the second agent.

3. The behavior determination device according to claim 2, wherein
the storage device stores the language model and personal information indicating a feature of a person,
the processor
executes generation processing of generating the first agent and the second agent based on the language model and the personal information, and
in the search processing, the processor searches for the plurality of simulated conversation paths by repeatedly executing the first generation and the second generation as the simulated conversation between the first agent and the second agent which are generated by the generation processing.

4. The behavior determination device according to claim 2, wherein
the behavior determination device is accessible to an external device that allows communication with the behavior determination device and stores the language model,
the storage device stores personal information indicating a feature of a person,
the processor executes agent generation processing of transmitting a generation request for the first agent and the second agent including the personal information to the external device and causing the external device to generate the first agent and the second agent based on the personal information, and
in the search processing, the processor searches for the plurality of simulated conversation paths by repeatedly executing the first generation and the second generation as the simulated conversation between the first agent and the second agent which are generated by the agent generation processing.

5. The behavior determination device according to claim 2, wherein
in the search processing, the processor determines the second agent that is an input destination of the simulated utterance candidate sentences based on an inter-vector distance between the internal states of the second agents, and inputs the simulated utterance candidate sentences to the determined second agent to generate the simulation response sentence as the consensus support sentence.

6. The behavior determination device according to claim 2, wherein
in the search processing, the processor determines the second agent that is an input destination of the simulated utterance candidate sentences based on an inter-vector distance between the internal state of the first agent and the internal state of the second agent, and inputs the simulated utterance candidate sentences to the determined second agent to generate the simulation response sentence as the consensus support sentence.

7. The behavior determination device according to claim 1, wherein
the processor calculates the evaluation value based on integrated free energy obtained by integrating free energy related to the group recognition of the participants in a free energy principle.

8. The behavior determination device according to claim 1, wherein
in the calculation processing, the processor calculates the evaluation value based on a sum of inter-vector distances of the internal states of the second agents.

9. The behavior determination device according to claim 1, wherein
in the calculation processing, the processor calculates, for each of the second agents, the evaluation value based on a sum of inter-vector distances of the internal states in a progress direction of the simulated conversation.

10. The behavior determination device according to claim 2, wherein
the storage device stores dialogue target information in which a dialogue target and a score for the dialogue target are associated with each other, and
in the calculation processing, the processor adjusts the evaluation value based on the score and an inter-vector distance between the dialogue target and the simulation response sentence generated in the second generation.

11. The behavior determination device according to claim 2, wherein
the processor executes setting processing of inputting an utterance sentence from the participant to the first agent as a result of outputting the specific simulated utterance candidate sentence in the output processing and setting a sentence output from the first agent to the consensus support sentence to be generated in the first generation.

12. A behavior determination method to be executed by a behavior determination device including a processor configured to execute a program, and a storage device configured to store the program, the behavior determination method comprising:
search processing of searching for, by executing a simulated conversation between a first agent that simulates a facilitator that supports consensus building in a conversation in a participant group based on a language model and a second agent that simulates participants participating in the conversation based on the language model, a plurality of simulated conversation paths from a start to an end of the simulated conversation;
calculation processing of calculating, based on an internal state indicating group recognition for the participant group of the participants in the second agent, an evaluation value for evaluating an utterance of a simulation response sentence in the simulation conversation generated by the second agent in the plurality of simulated conversation paths searched by the search processing;
extraction processing of extracting, based on the evaluation value calculated by the calculation processing, a specific simulated utterance candidate sentence from a plurality of simulated utterance candidate sentences from the first agent to the second agent at a start time of the simulated conversation; and
output processing of outputting the specific simulated utterance candidate sentence extracted by the extraction processing.

13. A behavior determination program that causes a processor to execute:
search processing of searching for, by executing a simulated conversation between a first agent that simulates a facilitator that supports consensus building in a conversation in a participant group based on a language model and a second agent that simulates participants participating in the conversation based on the language model, a plurality of simulated conversation paths from a start to an end of the simulated conversation;
calculation processing of calculating, based on an internal state indicating group recognition for the participant group of the participants in the second agent, an evaluation value for evaluating an utterance of a simulation response sentence in the simulation conversation generated by the second agent in the plurality of simulated conversation paths searched by the search processing;
extraction processing of extracting, based on the evaluation value calculated by the calculation processing, a specific simulated utterance candidate sentence from a plurality of simulated utterance candidate sentences from the first agent to the second agent at a start time of the simulated conversation; and
output processing of outputting the specific simulated utterance candidate sentence extracted by the extraction processing.
